(19) United States
(12) Patent Application Publication
(10) Pub. No.: US 2016/0224462 A1
(43) Pub. Date: Aug. 4, 2016

(54) DEVICES AND METHODS FOR GENERATING TEST CASES

(71) Applicant: Tencent Technology (Shenzhen) Company Limited, Shenzhen (CN)

(72) Inventor: Xueying Yang, Shenzhen (CN)

(21) Appl. No.: 15/092,797

(22) Filed: Apr. 7, 2016

Related U.S. Application Data
(63) Continuation of application No. PCT/CN2014/088131, filed on Oct. 8, 2014.

(30) Foreign Application Priority Data
Oct. 9, 2013 (CN) 201310468645.3

(51) Int. Cl. G06F 11/36

(52) U.S. Cl. CPC G06F 11/3684; G06F 11/3676

(57) ABSTRACT

Devices and methods are provided for generating test cases. For example, one or more test design models including test element information are created, the test element information containing product element information, quality standard information, development standard information, terminal characteristic information, software test technology information and final quality information; one or more test points of a test object are determined based on at least the test element information in the test design models; and one or more test cases are generated for the determined test points of the test object.

### CROSS-REFERENCES TO RELATED APPLICATIONS

The application claims priority to Chinese Patent Application No. 201310468645.3, filed Oct. 9, 2013, incorporated by reference herein for all purposes.

### BACKGROUND OF THE INVENTION

Certain embodiments of the present invention are directed to computer technology. More particularly, some embodiments of the invention provide devices and methods for system testing. Merely by way of example, some embodiments of the invention have been applied to test cases. But it would be recognized that the invention has a much broader range of applicability.

After a test object, such as software or a device installed with software, is developed, the test object is often tested to ensure stability and accuracy of the developed test object. When the test object is tested, a test case is usually designed and then the test object is tested using the designed test case.

Test cases are often designed using a requirement-based design method or a structure-based design method. According to the requirement-based design method, a test case is usually designed in strict accordance with certain requirements. However, the test case may omit non-functional attributes of the test object, which results in problems related to a narrow test range and incomplete and imprecise testing. According to the structure-based design method, functions of the test object are usually regarded as a top-down structure, and a test case is designed according to such a top-down structure. Since the test case is designed only according to the functions of the test object, the test case may also have the problems related to a narrow test range and incomplete and imprecise testing.

Hence it is highly desirable to improve the techniques for generating test cases.

### BRIEF SUMMARY OF THE INVENTION

According to one embodiment, a method is provided for generating test cases. For example, one or more test design models including test element information are created, the test element information containing product element information, quality standard information, development standard information, terminal characteristic information, software test technology information and final quality information; one or more test points of a test object are determined based on at least the test element information in the test design models; and one or more test cases are generated for the determined test points of the test object.

According to another embodiment, a device for generating test cases includes: a model creation unit configured to create one or more test design models including test element information, the test element information containing product element information, quality standard information, development standard information, terminal characteristic information, software test technology information and final quality information; a test point determination unit configured to determine one or more test points of a test object based on at least the test element information in the test design models; and a test case generation unit configured to generate one or more test cases for the determined test points of the test object.

According to yet another embodiment, a non-transitory computer readable storage medium includes programming instructions for generating test cases. The programming instructions are configured to cause one or more data processors to execute certain operations. For example, one or more test design models including test element information are created, the test element information containing product element information, quality standard information, development standard information, terminal characteristic information, software test technology information and final quality information; one or more test points of a test object are determined based on at least the test element information in the test design models; and one or more test cases are generated for the determined test points of the test object.

For example, the devices and methods described herein are configured to create a test design model including all test element information that affects testing, determine one or more test points of a test object more comprehensively and accurately based on the test element information in the test design model, and generate a test case according to the test points, so that the test case can test the test object more comprehensively and accurately and the quality of the test object is improved. As an example, the devices and methods described herein are configured to generate a test case directly based on test element information in a test design model, so as to enhance the test design efficiency.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for generating test cases according to one embodiment of the present invention.

FIG. 2 is a simplified diagram showing a method for generating test cases according to another embodiment of the present invention.

FIG. 3 is a simplified diagram showing a device for generating test cases according to one embodiment of the present invention.

### DETAILED DESCRIPTION OF THE INVENTION

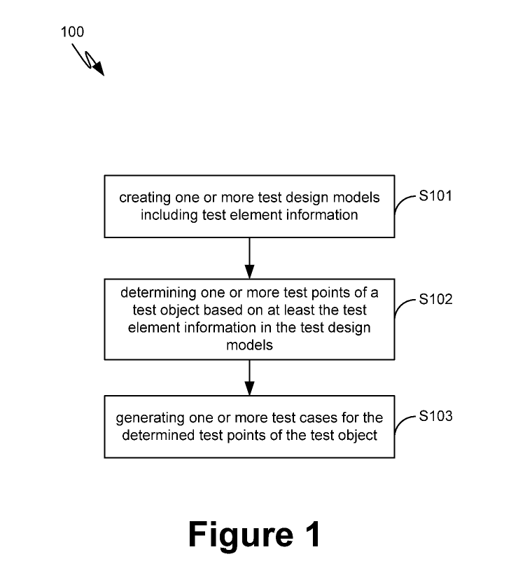

FIG. 1 is a simplified diagram showing a method for generating test cases according to one embodiment of the present invention. The diagram is merely an example, which should not unduly limit the scope of the claims. One of ordinary skill in the art would recognize many variations, alternatives, and modifications. The method 100 includes at least processes S101-S103.

According to one embodiment, a test object includes an object to be tested. For example, the test object includes software (e.g., including at least a sub-system), a device installed with software, etc. According to another embodiment, the process S101 includes: creating one or more test design models including test element information. For example, the test design models are established in advance. As an example, the test element information contains product element information, quality standard information, development standard information, terminal characteristic information, software test technology information, final quality information, etc. In another example, the product element information includes attribute information related to the test object, such as functions of the test object, modular structures of the test object, interactions between test objects, a data flow of the test object, operability of the test object, a response time of the test object, etc. In yet another example, the product element information includes structure information, function information, data information, operation information, time information, etc., related to the test object.

According to another embodiment, the structure information includes composition structure information of the test object. For example, the structure information includes communication connection between sub-systems of the test object, completeness of a hardware structure of the test object, completeness of codes of the test object, completeness of executable files and non-executable files of the test object, completeness of instructions of the test object, proper management of a use certificate of the test object, etc.

According to yet another embodiment, the function information is provided by the test object. For example, the function information includes completeness of user interaction interfaces, completeness of ports between sub-systems of the test object, compatibility of old and new versions of the test object, normal startup and shutdown of the test object, various detectable abnormities of the test object, automatic restoration of the test object in case of abnormities, etc.

In one embodiment, the data information includes data flow direction information in the test object. For example, software or a device installed with the software performs various logical data processing using one or more logical units. As an example, a certain logical unit receives data, performs logical processing of the received data, and transmits the processed data to a next logical unit for processing, etc., until a desired result is obtained. When the test object is tested, the flow direction information of data in the test object needs to be tested, according to some embodiments. For example, the data information includes processing of any input data, correct storage of persistent data, safe data encryption without bugs, normal running of data creation, flow, storage and destruction, etc.

In another embodiment, the operation information includes information for operating the test object. For example, the operation information includes operation requirements for different users, extreme operations not causing a crash of the test object, etc. As an example, time information includes processing information related to time for the test object. Particularly, the time information includes operation of the test object at low speed or high speed, normal running of the test object in case of a time change, disuse of the test object reaching an expiration time, etc.

In yet another embodiment, the quality standard information includes a quantitative standard to measure whether the test object is qualified or not. Particularly, the quality standard information includes product stability information, product robustness information, product availability information, product security information, etc. For example, the product stability information includes stability of the test object. Specifically, the product stability information includes stable operation of various functions of the test object, etc.

According to one embodiment, the product robustness information includes robustness of the test object. Particularly, the product robustness information includes normal error processing, restoring from errors without losing or destroying data, etc. For example, the product availability information includes availability of the test object. Specifically, the product availability information includes rapid learning and usage by a first-time user, simple operation method, simple interaction, no operation ambiguity, etc. As an example, the product security information includes security of the test object. Particularly, the product security information includes data storage security, network transmission security, etc.

According to another embodiment, the development standard information includes a standard which needs to be reached by the test object and is determined before or during a test objects development. Particularly, the development standard information includes testable information, maintainable information, localization information, etc. As an example, the testable information includes a testable standard to be reached by the test object, and includes a satisfactory unit test code coverage rate, qualified testability of the test object, etc. As another example, the maintainable information includes a maintainable standard to be reached by the test object, and includes good maintainability, lower maintenance cost of the test object, etc. As yet another example, the localization information includes a localization standard to be reached by the test object, and includes language localization of the test object, currency unit localization of the test object, culture localization of the test object, legal terms localization related to the test object, etc.

According to yet another embodiment, the terminal characteristic information includes information related to terminal equipment applicable to the test object, and includes operation system information, screen size information, network environment information, power information, memory information, processor information, etc. For example, the operation system information includes operation system information adopted by terminal equipment applicable to the test object, and includes compatibility of the test object with different operation systems, different versions on a same operation system capable of running normally, etc. As an example, the operation systems include IOS, Android, WP7, Symbian, etc. As another example, the screen size information includes a screen size of terminal equipment applicable to the test object, and includes normal running of the test object in various screen sizes, normal human-machine interaction in various screen sizes, etc.

In one embodiment, the software test technology information includes adoptable software test technology when a test case is designed for the test object. For example, the software test technology includes function test technology, domain test technology, pressure test technology, scenario test technology, automatic test technology, etc. As an example, the function test technology includes technology for design of the test case based on the functions provided by the test object, and includes testing each function provided by the test object for ability to operate normally, testing whether the operation of each function reaches an expected result, etc.

In another embodiment, the domain test technology includes collecting all input and output data of the test object, decomposing and combining the collected data, inputting the different data into the test object, etc. For example, the pressure test technology includes seeking out a module that is prone to have a performance bottleneck in a system, determining a range influenced by a performance test, producing large-scale data so as to perform a pressure test on the system, etc.

In yet another embodiment, the scenario test technology includes creating various possibly operating scenarios for the system, and testing based on different scenarios without any interruption, etc. For example, the automatic test technology includes running a large number of different test cases, collecting the test cases capable of automatic operation, implementing an automated operation mechanism, implementing and running an automated test case by codes, etc. As an example, the final quality information includes a quality standard to be reached by a test result that is obtained by testing the test object, such as, a pass rate of test cases, passage of a pressure test, meeting a development standard, satisfying requirements of all terminal characteristics, etc.

According to some embodiments, the process S102 includes: determining one or more test points of a test object based on at least the test element information in the test design models. For example, one or more test points of the test object are determined based on the test element information in the test design model as follows: the test points related to a product element are determined based on the product element information in the test design model. Specifically, the test points of the test object can be determined based on structure information, function information, data information, operation information and time information included in the product element information. For instance, if the test object is mobile phone manager software provided with an instant messaging function, it can be determined that the mobile phone manager software provides the instant messaging function based on the function information in the product element information. Thus, the following test points can be obtained: a correct instant messaging account and a normal login password can be used to log in normally, and the log in fails with an incorrect instant messaging account or an incorrect login password.

According to certain embodiments, one or more test points related to a quality standard are determined based on the quality standard information in the test design model. Specifically, the test point of the test object can be determined based on the product stability information, the product robustness information, the product availability information and the product security information included in the quality standard information respectively. For example, if the test object is the mobile phone manager software provided with the instant messaging function, it can be determined that the mobile phone manager software needs to satisfy the requirement of data storage security when providing the instant messaging function based on the product security information in the quality standard information. As an example, the following test points can be obtained: a stored instant messaging account and a stored password need to be encrypted.

According to some embodiments, one or more test points related to a development standard are determined based on the development standard information in the test design model. Specifically, the test points of the test object can be determined based on the testable information, the maintainable information and the localization information included in the development standard information respectively. For example, if the test object is the mobile phone manager software provided with the instant messaging function, it can be determined that the mobile phone manager software needs to satisfy the requirement of language localization when providing the instant messaging function based on the localization information in the development standard information. As an example, the following test points can be obtained: an instant messaging login function with various language versions.

According to certain embodiments, one or more test points related to one or more terminal characteristics are determined based on the terminal characteristic information in the test design model. Specifically, the test points of the test object can be determined based on the operation system information, the screen size information, the network environment information, the power information, the memory information and the processor information included in the terminal characteristic information respectively. For example, if the test object is the mobile phone manager software provided with the instant messaging function, the following test points can be determined based on the operation system information in the terminal characteristic information: whether the instant messaging login function provided by the mobile phone manager software can be suitable for various operation systems.

According to some embodiments, one or more test points related to software test technology are determined based on the software test technology information in the test design model. Specifically, the test points of the test object can be determined based on the function test technology, the domain test technology, the pressure test technology, the scenario test technology and the automatic test technology included in the software test technology information. For example, if the test object is the mobile phone manager software provided with the instant messaging function, the following test points can be determined based on the pressure test technology in the software test technology information: when a preset number of users log in simultaneously, whether the instant messaging function provided by mobile phone key software can run normally, etc.

According to certain embodiments, one or more test points related to final quality are determined based on the final quality information in the test design model. For example, if the test object is the mobile phone manager software provided with the instant messaging function, the following test points can be determined based on the final quality information: whether pass rates of the test cases reach a preset value, whether the test cases pass a pressure test, meets a development standard and satisfies the requirements of all terminal characteristics, etc.

According to some embodiments, the process S103 includes: generating one or more test cases for the determined test points of the test object. For example, any known methods can be used for generating the test cases based on the test points of the test object. By creating the test design model, one or more test points of the test object are determined based on the test element information in the test design model, so that the determined test points of the test object are more comprehensive and accurate, according to some embodiments. Then one or more test cases are generated based on the determined test points of the test object so that the generated test cases can test the test object more comprehensively and accurately and the quality of the test object is improved, according to certain embodiments. For example, as the test cases can be directly generated based on the test element information in the test design model, the test design efficiency is greatly enhanced.

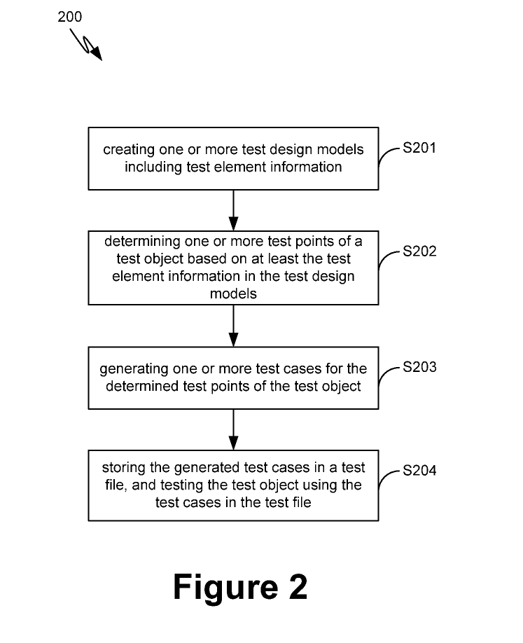

FIG. 2 is a simplified diagram showing a method for generating test cases according to another embodiment of the present invention. The diagram is merely an example, which should not unduly limit the scope of the claims. One of ordinary skill in the art would recognize many variations, alternatives, and modifications. The method 200 includes at least processes S201-S204.

According to some embodiments, the processes S201, S202, and S203 are the same as the processes S101, S102, and S103 of the method 100 as shown in FIG. 1, respectively. For example, the process S204 includes: storing the generated test cases in a test file and testing the test object using the test cases in the test file. As an example, in order to automatically test the test object based on the test cases in the test file, when the generated test cases are stored in the test file, the test cases are ranked in a preset test sequence, and the test cases in the test file are called to test the test object in accordance with the ranked sequence.

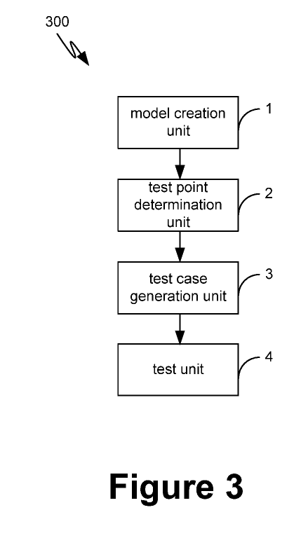

FIG. 3 is a simplified diagram showing a device for generating test cases according to one embodiment of the present invention. The diagram is merely an example, which should not unduly limit the scope of the claims. One of ordinary skill in the art would recognize many variations, alternatives, and modifications. The device 300 includes: a model creation unit 1, a test point determination unit 2, and a test case generation unit 3.

According to some embodiments, the device 300 is used in electronic equipment, such as a computer. For example, the device 300 includes a software unit, a hardware unit or a combination of software and hardware within electronic equipment (e.g., a computer). As an example, the device 300 serves as an independent widget integrated into electronic equipment such as a computer. As another example, the device 300 runs in an application system of electronic equipment such as a computer.

According to one embodiment, the model creation unit 1 is configured to create one or more test design models including test element information, the test element information containing product element information, quality standard information, development standard information, terminal characteristic information, software test technology information and final quality information. For example, the product element information includes attribute information related to the test object, such as functions of the test object, modular structures of the test object, interactions between test objects, a data flow of the test object, operability of the test object, a response time of the test object, etc. In another example, the product element information includes structure information, function information, data information, operation information, time information, etc., related to the test object.

According to another embodiment, the structure information includes composition structure information of the test object. For example, the structure information includes communication connection between sub-systems of the test object, completeness of a hardware structure of the test object, completeness of codes of the test object, completeness of executable files and non-executable files of the test object, completeness of instructions of the test object, proper management of a use certificate of the test object, etc.

According to yet another embodiment, the function information is provided by the test object. For example, the function information includes completeness of user interaction interfaces, completeness of ports between sub-systems of the test object, compatibility of old and new versions of the test object, normal startup and shutdown of the test object, various detectable abnormities of the test object, automatic restoration of the test object in case of abnormities, etc.

In one embodiment, the data information includes data flow direction information in the test object. For example, software or a device installed with the software performs various logical data processing using one or more logical units. As an example, a certain logical unit receives data, performs logical processing of the received data, and transmits the processed data to a next logical unit for processing, etc., until a desired result is obtained. When the test object is tested, the flow direction information of data in the test object needs to be tested, according to some embodiments. For example, the data information includes processing of any input data, correct storage of persistent data, safe data encryption without bugs, normal running of data creation, flow, storage and destruction, etc.

In another embodiment, the operation information includes information for operating the test object. For example, the operation information includes operation requirements for different users, extreme operations not causing a crash of the test object, etc. As an example, time information includes processing information related to time for the test object. Particularly, the time information includes operation of the test object at low speed or high speed, normal running of the test object in case of a time change, disuse of the test object reaching an expiration time, etc.

In yet another embodiment, the quality standard information includes a quantitative standard to measure whether the test object is qualified or not. Particularly, the quality standard information includes product stability information, product robustness information, product availability information, product security information, etc. For example, the product stability information includes stability of the test object. Specifically, the product stability information includes stable operation of various functions of the test object, etc.

According to one embodiment, the product robustness information includes robustness of the test object. Particularly, the product robustness information includes normal error processing, restoring from errors without losing or destroying data, etc. For example, the product availability information includes availability of the test object. Specifically, the product availability information includes rapid learning and usage by a first-time user, simple operation method, simple interaction, no operation ambiguity, etc. As an example, the product security information includes security of the test object. Particularly, the product security information includes data storage security, network transmission security, etc.

According to another embodiment, the development standard information includes a standard which needs to be reached by the test object and is determined before or during a test object development. Particularly, the development standard information includes testable information, maintainable information, localization information, etc. As an example, the testable information includes a testable standard to be reached by the test object, and includes a satisfactory unit test code coverage rate, qualified testability of the test object, etc. As another example, the maintainable information includes a maintainable standard to be reached by the test object, and includes good maintainability, lower maintenance cost of the test object, etc. As yet another example, the localization information includes a localization standard to be reached by the test object, and includes language localization of the test object, currency unit localization of the test object, culture localization of the test object, legal terms localization related to the test object, etc.

According to yet another embodiment, the terminal characteristic information includes information related to terminal equipment applicable to the test object, and includes operation system information, screen size information, network environment information, power information, memory information, processor information, etc. For example, the operation system information includes operation system information adopted by terminal equipment applicable to the test object, and includes compatibility of the test object with different operation systems, different versions on a same operation system capable of running normally, etc. As an example, the operation systems include IOS, Android, WP7, Symbian, etc. As another example, the screen size information includes a screen size of terminal equipment applicable to the test object, and includes normal running of the test object in various screen sizes, normal human-machine interaction in various screen sizes, etc.

In one embodiment, the software test technology information includes adoptable software test technology when a test case is designed for the test object. For example, the software test technology includes function test technology, domain test technology, pressure test technology, scenario test technology, automatic test technology, etc. As an example, the function test technology includes technology for design of the test case based on the functions provided by the test object, and includes testing each function provided by the test object for ability to operate normally, testing whether the operation of each function reaches an expected result, etc.

In another embodiment, the domain test technology includes collecting all input and output data of the test object, decomposing and combining the collected data, inputting the different data into the test object, etc. For example, the pressure test technology includes seeking out a module that is prone to have a performance bottleneck in a system, determining a range influenced by a performance test, producing large-scale data so as to perform a pressure test on the system, etc.

In yet another embodiment, the scenario test technology includes creating various possibly operating scenarios for the system, and testing based on different scenarios without any interruption, etc. For example, the automatic test technology includes running a large number of different test cases, collecting the test cases capable of automatic operation, implementing an automated operation mechanism, implementing and running an automated test case by codes, etc. As an example, the final quality information includes a quality standard to be reached by a test result that is obtained by testing the test object, such as, a pass rate of test cases, passage of a pressure test, meeting a development standard, satisfying requirements of all terminal characteristics, etc.

According to one embodiment, the test point determination unit 2 is configured to determine one or more test points of a test object based on at least the test element information in the test design models. For example, the test point determination unit 2 is further configured to: determine a first test point related to a product element based on at least the product element information in the test design models; determine a second test point related to a quality standard based on at least the quality standard information in the test design models; determine a third test point related to a development standard based on at least the development standard information in the test design models; determine a fourth test point related to a terminal characteristic based on at least the terminal characteristic information in the test design models; determine a fifth test point related to software test technology based on at least the software test technology information in the test design models; and determine a sixth test point related to final quality based on at least the final quality information in the test design models.

According to another embodiment, the test case generation unit 3 is configured to generate one or more test cases for the determined test points of the test object. For example, the device 300 further includes: a test unit 4 configured to store the generated test cases in a test file and test the test object using the test cases in the test file.

According to one embodiment, a method is provided for generating test cases. For example, one or more test design models including test element information are created, the test element information containing product element information, quality standard information, development standard information, terminal characteristic information, software test technology information and final quality information; one or more test points of a test object are determined based on at least the test element information in the test design models; and one or more test cases are generated for the determined test points of the test object. For example, the method is implemented according to at least FIG. 1 and/or FIG. 2.

According to another embodiment, a device for generating test cases includes: a model creation unit configured to create one or more test design models including test element information, the test element information containing product element information, quality standard information, development standard information, terminal characteristic information, software test technology information and final quality information; a test point determination unit configured to determine one or more test points of a test object based on at least the test element information in the test design models; and a test case generation unit configured to generate one or more test cases for the determined test points of the test object. For example, the device is implemented according to at least FIG. 3.

According to yet another embodiment, a non-transitory computer readable storage medium includes programming instructions for generating test cases. The programming instructions are configured to cause one or more data processors to execute certain operations. For example, one or more test design models including test element information are created, the test element information containing product element information, quality standard information, development standard information, terminal characteristic information, software test technology information and final quality information; one or more test points of a test object are determined based on at least the test element information in the test design models; and one or more test cases are generated for the determined test points of the test object. For example, the storage medium is implemented according to at least FIG. 1 and/or FIG. 2.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

what is claimed is:

1. A method for generating test cases, the method comprising:
creating one or more test design models including test element information, the test element information containing product element information, quality standard information, development standard information, terminal characteristic information, software test technology information and final quality information;
determining one or more test points of a test object based on at least the test element information in the test design models; and
generating one or more test cases for the determined test points of the test object.

2. The method of claim 1, wherein the determining one or more test points of a test object based on at least the test element information in the test design models includes:
determining a first test point related to a product element based on at least the product element information in the test design models;
determining a second test point related to a quality standard based on at least the quality standard information in the test design models;
determining a third test point related to a development standard based on at least the development standard information in the test design models;
determining a fourth test point related to a terminal characteristic based on at least the terminal characteristic information in the test design models;
determining a fifth test point related to software test technology based on at least the software test technology information in the test design models; and
determining a sixth test point related to final quality based on at least the final quality information in the test design models.

3. The method of claim 1, wherein the product element information includes: structure information, function information, data information, operation information and time information related to the test object.

4. The method of claim 1, wherein the quality standard information includes: product stability information, product robustness information, product availability information and product security information.

5. The method of claim 1, wherein the development standard information includes: testable information, maintainable information and localization information.

6. The method of claim 1, wherein the terminal characteristic information includes: operation system information, screen size information, network environment information, power information, memory information and processor information.

7. The method of claim 1, wherein the software test technology information includes: function test technology, domain test technology, pressure test technology, scenario test technology and automatic test technology.

8. The method of claim 1, further comprising:
storing the generated test cases in a test file; and
testing the test object using the test cases in the test file.

9. A device for generating test cases, the device comprising: a memory, and a processor in communication with the memory, wherein the memory stores a model creation unit, a test point determination unit and a test case generation unit, and the processor processes:
the model creation unit to create one or more test design models including test element information, the test element information containing product element information, quality standard information, development standard information, terminal characteristic information, software test technology information and final quality information;
the test point determination unit to determine one or more test points of a test object based on at least the test element information in the test design models; and
the test case generation unit to generate one or more test cases for the determined test points of the test object.

10. The device of claim 9, wherein the processor further processes the test point determination unit to:
determine a first test point related to a product element based on at least the product element information in the test design models;
determine a second test point related to a quality standard based on at least the quality standard information in the test design models;
determine a third test point related to a development standard based on at least the development standard information in the test design models;
determine a fourth test point related to a terminal characteristic based on at least the terminal characteristic information in the test design models;
determine a fifth test point related to software test technology based on at least the software test technology information in the test design models; and
determine a sixth test point related to final quality based on at least the final quality information in the test design models.

11. The device of claim 9, wherein:
the product element information includes: structure information, function information, data information, operation information and time information related to the test object;
the quality standard information includes: product stability information, product robustness information, product availability information and product security information;
the development standard information includes: testable information, maintainable information and localization information;
the terminal characteristic information includes: operation system information, screen size information, network environment information, power information, memory information and processor information; and
the software test technology information includes: function test technology, domain test technology, pressure test technology, scenario test technology and automatic test technology.

12. The device of claim 9, wherein the memory further stores a test unit, and the processor processes the test unit to store the generated test cases in a test file and test the test object using the test cases in the test file.

13. A non-transitory computer readable storage medium comprising programming instructions for generating test cases, the programming instructions configured to cause one or more data processors to execute operations comprising:
creating one or more test design models including test element information, the test element information containing product element information, quality standard information, development standard information, terminal characteristic information, software test technology information and final quality information;
determining one or more test points of a test object based on at least the test element information in the test design models; and
generating one or more test cases for the determined test points of the test object.
